(19) United States
(12) Patent Application Publication
(10) Pub. No.: US 2025/0315850 A1
(43) Pub. Date: Oct. 9, 2025

(54) SYSTEMS AND METHODS FOR FORECASTING NICHE MARKET TRENDS USING ARTIFICIAL INTELLIGENCE AND SOCIAL MEDIA DATA

(71) Applicant: Wissee, Inc., Sammamish, WA (US)

(72) Inventors: Huina Mao, Sammamish, WA (US); Xin Shuai, Renton, WA (US)

(73) Assignee: Wissee, Inc., Sammamish, WA (US)

(21) Appl. No.: 19/171,750

(22) Filed: Apr. 7, 2025

Related U.S. Application Data
(60) Provisional application No. 63/575,876, filed on Apr. 8, 2024.

(51) Int. Cl. G06Q 30/0202; G06F 16/2457; G06Q 30/0601; G06Q 50/00

(52) U.S. Cl. CPC G06Q 30/0202; G06F 16/24573; G06Q 30/0631; G06Q 50/01

(57) ABSTRACT

In some embodiments, a method for determining fashion trend includes, by one or more processors: determining fashion data associated with at least a given fashion style; extracting multimodal fashion features from the fashion data; determining historical fashion data associated with the given fashion style; using a trained fashion trend classifier to determine a fashion trend for the given fashion style based on the multimodal fashion features and the historical fashion data associated with the given fashion style; and causing to display the fashion trend for the given fashion style. The fashion data associated with the given fashion style may be aggregated from a collection of fashion data by parsing fashion entities from each fashion item in the collection of fashion data; using a trained fashion style classifier to detect fashion style for each fashion item, and aggregating the fashion items associated with the given fashion style.

### RELATED APPLICATIONS

This application claims the benefit under 35 U.S.C. § 119 (e) of U.S. Provisional Application No. 63/575,876, filed Apr. 8, 2024, the entire contents of which are incorporated herein by reference.

### FIELD

This technology relates to niche market trends forecasting, and more particularly to fashion trend forecasting.

### BACKGROUND

In the rapidly evolving landscape of fashion, staying ahead of trends is crucial for success. While existing approaches for trend forecasting primarily rely on runway data and insights from industry experts, there exists a significant gap in capturing real-time consumer sentiments and behaviors. For example, conventional methods can only provide qualitative predictions for the next year or longer.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 is a schematic diagram of an example system for fashion trend analysis, according to some embodiments.

FIGS. 2A and 2B illustrate examples of fashion knowledge graph, according to some embodiments.

FIG. 3 is a flow diagram of an example process of generating/updating a fashion knowledge base, according to some embodiments.

FIG. 4 illustrates an example of fashion attributes tagging using a multi-modal artificial intelligence model, according to some embodiments.

FIG. 5A is a schematic diagram of a fashion style classification system for use in the fashion attributes tagging, according to some embodiments.

FIG. 5B is a schematic diagram of a structure of a fashion style classifier for use in the fashion style classification system in FIG. 5A, according to some embodiments.

FIG. 6 is a flow diagram of an example process of determining fashion trends, according to some embodiments.

FIG. 7 is a schematic diagram of a fashion trend classifier system, according to some embodiments.

FIG. 8 illustrates examples of fashion trend trajectories and classifications as can be determined by a fashion trend classifier in FIG. 7, according to some embodiments.

FIG. 9A is a flow diagram of an example process of generating a response using a fashion knowledge base, according to some embodiments.

FIG. 9B is a flow diagram of an example process of product inventory recommendation, according to some embodiments.

FIG. 9C is a flow diagram of an example process of influencer-based insights analysis, according to some embodiments.

FIG. 9D is a flow diagram of an example process of fashion trend analysis, according to some embodiments.

FIG. 9E is a flow diagram of an example process of data driven AI fashion design, according to some embodiments.

FIG. 9F is a flow diagram of an example process of discovering new fashion aesthetics, according to some embodiments.

FIG. 10A is an example of a fashion social media post, according to some embodiments.

FIG. 10B is an example of a summary generated by the system and method described in the present disclosure for the fashion social media post shown in FIG. 10A, according to some embodiments.

FIG. 11A is an example of graphical user interface that displays fashion aesthetic trend information generated by the system and method described in the present disclosure, according to some embodiments.

FIG. 11B is an example of graphical user interface that displays fashion product trend information generated by the system and method described in the present disclosure, according to some embodiments.

FIG. 11C is an example of graphical user interface that displays fashion design trend information generated by the system and method described in the present disclosure, according to some embodiments.

FIG. 12 depicts an example of internal hardware that may be included in any electronic device or computing system that may be used to perform any of the aspects of the techniques and embodiments disclosed herein, according to some embodiments.

### DETAILED DESCRIPTION

Existing approaches for trend forecasting primarily rely on runway data and insights from industry experts who analyze the limited data sources to provide qualitative, intuition-driven reports. These approaches are usually limited to data related to designer brands and do not consider real-time market activities, in particular fashion related social media activities (e.g., influencers) and consumer sentiments and behaviors. These expert-written reports often correspond to long-term market trends (e.g., one year or longer) qualitatively. Other existing approaches use artificial intelligence (AI) such as large language model (LLM) to predict fashion trends. Yet, existing AI tools tend to have basic knowledge on a superficial level and are not trained specifically on fashion data. In particular, these AI tools do not produce fashion insights with granularity and cannot be practically useful in recommending or designing an outfit. In today's fashion industry, small batch production, short lead time, multi-channel distribution, and customer-centric demands all require even quicker and more agile prediction of fashion trends with higher precision.

Accordingly, the inventors have developed systems and methods that utilize social media, which has emerged as a powerful force in shaping a given market trend, such as fashion trends, where social media represents the authentic voices of consumers and reflect market demands in real-time. Various systems and methods are provided that bridge the gap between supply and demand by aggregating and analyzing social media data alongside retail supply, providing users with actionable insights into emerging trends and consumer preferences with improved speed and accuracy. For example, the various embodiments described in the present disclosure utilize social media insights to offer near-term forecasting, for example, ranging from 1 to 3 months, a much shorter term forecasting than conventional methods.

The various embodiments described in the present disclosure enable a wide range of fashion applications and provide advantages over existing approaches in Real-time Social Media Driven Consumer Insights, Vertical Niche Market Focus, and AI-Powered Predictive Analytics.

Real-time Social Media Driven Consumer Insights. Unlike traditional methods that rely on runway data sources and expert opinions, the system utilizes social media to capture real-time consumer sentiments and behaviors. By analyzing social media conversations, influencer activity, and consumer engagement metrics, the system provides users with immediate insights into emerging trends and market demands. While existing approaches typically offer long-term predictions spanning a year or more, the system focuses on providing near-term forecasting ranging from 1 to 3 months and enables users to anticipate trends quickly and accurately.

Vertical Niche Market Focus. Unlike traditional fashion analytics platforms, the system's focus extends beyond mainstream markets to encompass niche segments such as sustainable fashion, plus-size apparel, and Gen Z trends. By delving deep into these verticals, the system uncovers unique opportunities and helps users tap into underserved markets.

AI-Powered Predictive Analytics. The system utilizes AI algorithms to predict future fashion trends based on social media data and retail trends. By forecasting trends for a short term, e.g., the next 1-3 months, the system enables users to anticipate market shifts and adapt their strategies accordingly.

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect. In the present disclosure, fashion style, aesthetics, and aesthetic style are interchangeable.

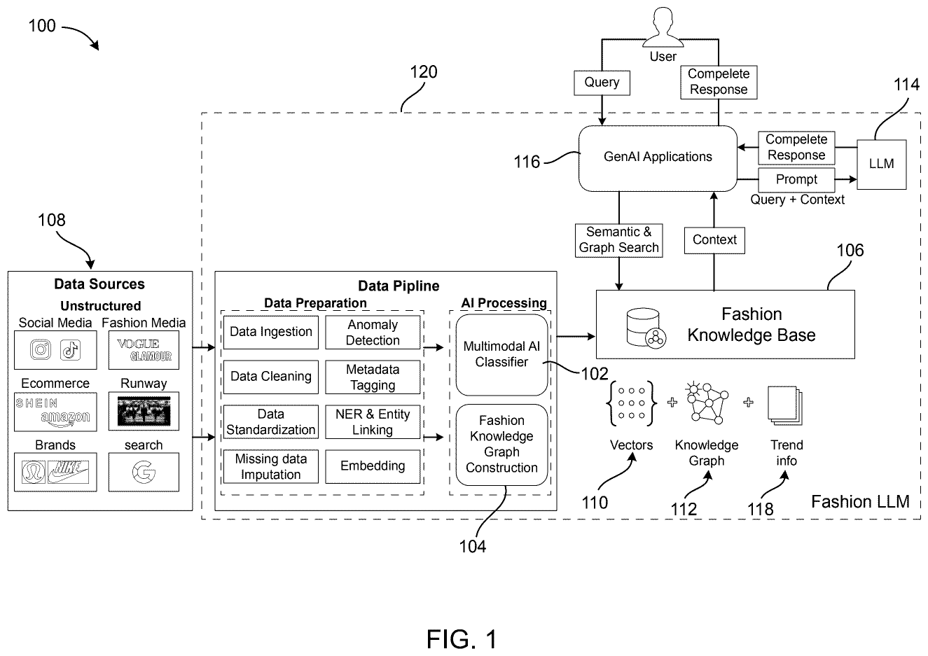

FIG. 1 is a schematic diagram of an example system 100 for fashion trend analysis, according to some embodiments. In some embodiments, system 100 may include a FashionLLM 120 that includes a multimodal AI classifier model 102, a fashion knowledge graph construction unit 104, and a fashion knowledge base 106. Fashion knowledge base 106 may store vectors 110 and knowledge graph 112, which are respectively provided by multimodal AI classifier model 102 and fashion knowledge graph construction unit 104.

Multimodal AI classifier model 102 may include one or more classifiers for extracting and encoding rich fashion-specific features (e.g., fashion entities, clothing categories, fashion attributes, materials, patterns, and aesthetics etc.) from various data sources 108. Examples of these various data sources 108 may include: social media posts (including image, caption, engagement data), e-commerce products (including product photo, title/description, and category), and runway look (including model photo, show notes, and designer name).

The multimodal AI classifier model 102 may be a deep learning model trained on diverse fashion datasets, including images, text, and structured attributes. The multimodal AI classifier 102 may extract the fashion features and convert them to vectors 110. In some examples, the vectors 110 may include multimodal vectors including text and image features such as text embeddings and image embeddings. Text embeddings may be derived from textual descriptions of fashion products, generated by AI parsing of product pages, social media posts, and magazine articles. Image embeddings may be extracted from product images, social media visuals, and runway photos using deep vision models as will be further described.

Fashion knowledge graph construction unit 104 may be configured to construct the fashion knowledge graph 112, which is a structured knowledge base that captures relationships between fashion entities, such as brands, styles, influences. The fashion knowledge graph 112 may be constructed using data from retail catalogs, social media, and runway shows, allowing for contextual understanding and inference.

As shown in FIG. 1, FashionLLM 120 may further include a large language model (LLM) 114 and GenAI applications 116. FashionLLM 120 may be enabled to allow retrieval-augmented generation (RAG) by enhancing the LLM with domain-specific retrieval capabilities. For example, the vector outputs of the multimodal AI classifier 110 and fashion knowledge graph 112 are transformed into a fashion knowledge base 106, which serves as the retrieval mechanism for the LLM 114. This enables the model to generate highly relevant, context-aware responses by grounding its reasoning in structured fashion data.

In non-limiting examples, in a fashion trend application (e.g., GenAI application 116), a user queries the system with a query that includes information about an outfit, where the user asks the system for the style and trend insights. The system may use the query from the user to retrieve augmented context from the fashion knowledge base 106 (e.g., using semantic and graph search) and pass the augmented context to the LLM 114, which may use the augmented context to generate a complete response to be returned to the user. As such, the FashionLLM 120 dynamically retrieves relevant fashion insights from the knowledge base to enhance its generative responses. By combining structured knowledge (e.g., knowledge base) with advanced multimodal AI, FashionLLM can deliver highly accurate, context-aware fashion intelligence, making it a powerful tool for trend forecasting, personalized recommendations, and automated fashion content generation. Details of the system are further described in the present disclosure.

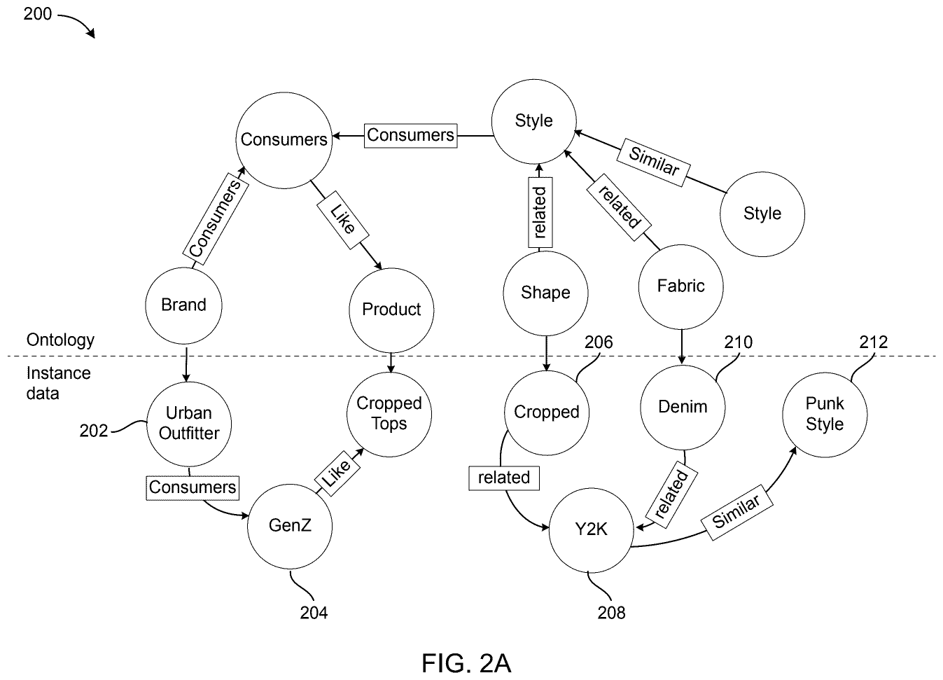

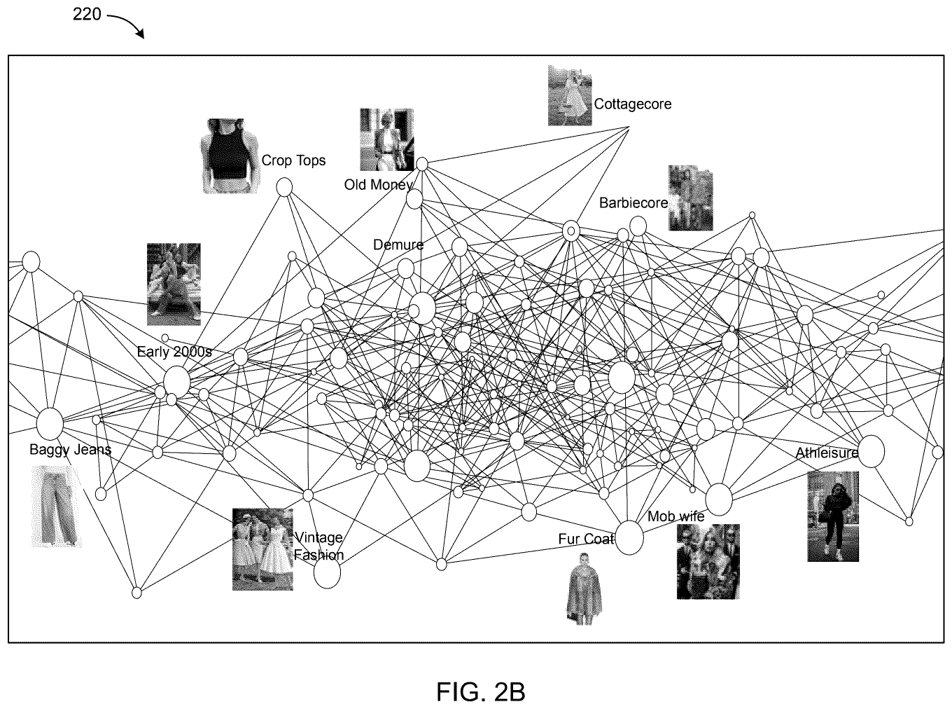

FIGS. 2A and 2B illustrate examples of fashion knowledge graph, according to some embodiments. A fashion knowledge graph (e.g., 200, 220) may include a plurality of nodes and edges between the nodes, which respectively represent fashion-related concepts and their co-occurrence relationships in products from social media, e-commerce, and runway data. For example, a node may represent a fashion entity that may include a variety of data types, such as:
product categories (e.g., Jacket, Dress, Sneakers, Handbag)
fashion attributes (e.g., Color (Black, Beige)
material (Leather, Cotton)
pattern (Striped, Floral)
fit (Oversized, Slim-fit)
aesthetics (fashion styles) (e.g., Streetwear, Minimalist, Gothic, Bohemian)
brands (e.g., Gucci, Prada, Off-White, Jacquemus)
influencers and celebrities (E.g., Kendall Jenner, Hailey Bieber, Bella Hadid, Kim Kardashian).

The edges between the nodes in the fashion knowledge graph may represent the relationships between nodes based on their co-occurrence in fashion products from social media, e-commerce, and runway data. These relationships identify common associations in real-world fashion. Examples of the relationships may include:
Co-occurs With (frequently seen together in products):
   Example: Black (Color)⇄Leather (Material) (often found in jackets)
   Example: Streetwear (Aesthetic)⇄Sneakers (Product Category)
Often Paired With (commonly styled together):
   Example: Trench Coat (Product)⇄Minimalist (Aesthetic Style)
   Example: Floral Dress (Product)⇄Beige (Color)
Worn by Influencer (commonly associated with a celebrity or influencer):
   Example: Bella Hadid (Influencer)⇄Y2K (Aesthetic Style)
   Example: Hailey Bieber (Influencer)⇄Oversized Blazer (Product Category)
Common in Brand (frequently appearing in a specific brand's collection):
   Example: Gucci (Brand)⇄Monogram Print (Pattern)
   Example: Off-White (Brand)⇄Streetwear (Aesthetic Style)

In non-limiting examples, in fashion knowledge graph 200 (FIG. 2A), brand Urban Outfitters 202 clothing are consumed by GenZ consumers group 204. The Y2K aesthetic style 208 defines certain fashion attributes such as cropped shape 206 and denim materials 210 and is also similar to Punk aesthetic style 212. FIG. 2B illustrates examples of fashion knowledge graph 220 highlighting the aesthetic nodes and their relationships with other nodes.

By leveraging co-occurrence data from social media, e-commerce, and runway sources, the fashion knowledge graph helps FashionLLM to identify key fashion elements and their real-world associations for use with fashion trend analysis as will be further described in detail in the present disclosure.

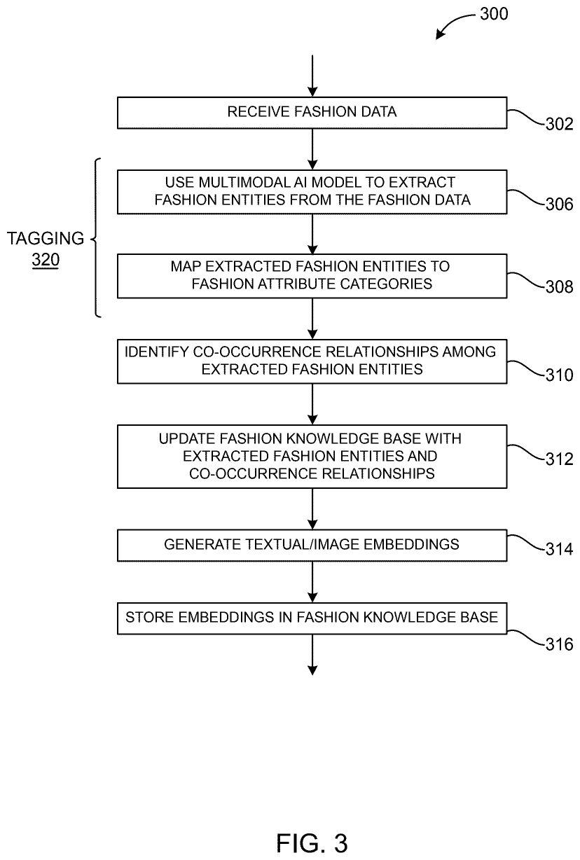

FIG. 3 is a flow diagram of an example process 300 for constructing a fashion knowledge base, according to some embodiments. In some embodiments, process 300 may be implemented to generate the vectors 110 and knowledge graph 112 in FashionLLM 120. Process 300 may include receiving fashion data, at act 302. As shown in FIG. 1, the fashion data may come from various data sources 108 for extracting text embeddings or image embeddings. For examples, fashion data may include social media, fashion media (e.g., Vogue, Glamour), runway, e-commerce (e.g., Shein, Amazon), brands (e.g., Nike), and search interests (e.g., Google search).

Returning to FIG. 3, process 300 may further include tagging at 320. Tagging may be performed in the multimodal AI classifier (102 in FIG. 1). Tagging 320 may include detecting from fashion data (e.g., social media posts, including both text and images) fashion attributes (e.g., color, fabric, pattern), product categories (e.g., dress, jacket), and aesthetic styles (e.g., streetwear, minimalist) using a combination of language and vision models. For example, tagging 320 may include extracting fashion entities using a multimodal AI model, at act 306. In some embodiments, multimodal AI model include a combination of AI models for different modalities. For example, multimodal AI model may include NLP models for extracting attributes from product titles, descriptions, and social media captions and deep learning-based vision models for identifying product type, color, pattern, fabric, and details. The multimodal AI model may be capable of jointly analyzing multiple modalities (e.g., text, image, video). It can be trained on multimodal fashion data and executed to detect fashion attributes for a given new input fashion data (e.g., social media post) based on the understanding of text, images, and/or other modalities.

In non-limiting examples, the NLP model(s) and vision model(s) in the multimodal AI model described above and further herein may be trained jointly using available pretrained models, then fine-tuned on fashion-specific datasets collected from e-commerce platforms, social media posts, and runway images to improve accuracy and domain relevance. For example, ProBERT and FashionCLIP models may be used as the starting backbone encoding models for text and image, which are then fine-tuned together to enable integrated understanding of both text and image inputs. ProBERT and FashionCLIP models and training thereof are further described in Liu, J., et al., “Fine-grained Product Attribute Extraction from Titles and Descriptions Using BERT,” EMNLP Industry Track, 2020, and in Patrick John Chia et al., FashionCLIP: Contrastive Language and Vision Learning of General Fashion Concepts, 2022, https://arxiv.org/abs/2204.03972, the disclosure of these references are incorporated herein by reference. It is appreciated that other suitable models may be used to understand text and image (or other modalities). Training of the multimodal AI model will be described further in detail in the present disclosure.

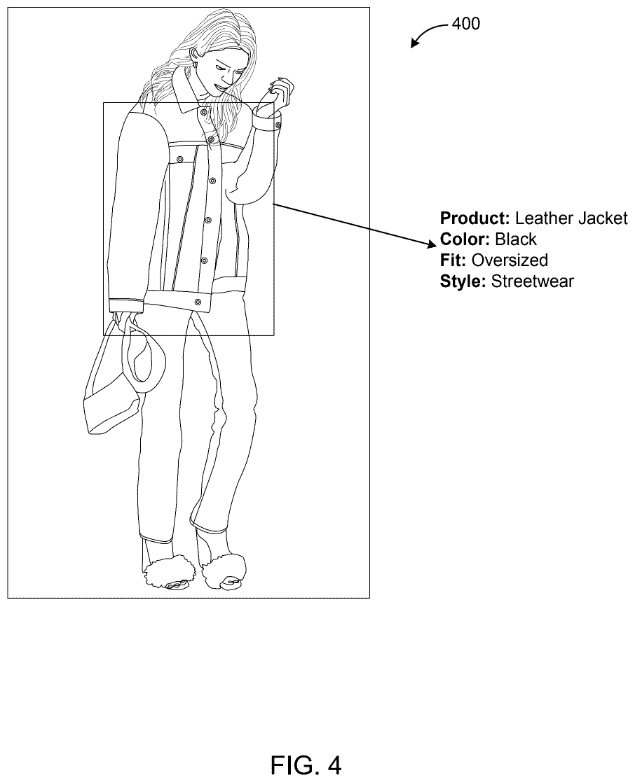

Additionally, tagging 320 may further include mapping extracted fashion entities to fashion attribute categories, at act 308, where the extracted information is structured into predefined fashion attribute categories (e.g., Color→Black, Pattern→Striped, Material→Cotton). Having described tagging 320, FIG. 4 illustrates an example of fashion attributes tagging using a multi-model artificial intelligence model, according to some embodiments. The input to the tagging is a social media post 400 of Kendall Jenner in a black leather jacket. The tagging output may include the extracted fashion entities and the mapped product attribute categories:
Product: Leather Jacket
Color: Black
Fit: Oversized
Style: Streetwear

In FIG. 3, process 300 may further include identifying co-occurrence relationships among extracted fashion entities, at act 310, by associating extracted fashion entities that appear together in the same post or product. It is appreciated that the extracted fashion entities may be obtained from act 306. Process 300 may proceed to act 312 to construct the fashion knowledge base using the extracted fashion entities and co-occurrence relationships. For example, the extracted fashion entities and the co-occurrence relationships are further used to construct the nodes and relationship edges in the fashion knowledge graph (e.g., 112 in FIG. 1).

In some embodiments, process 300 may further include generating vectors (e.g., 110 in FIG. 1), at act 314. In some examples, the vectors may be text and/or image embeddings. Text embeddings may be generated from textual descriptions of fashion products, generated by AI parsing of product pages, social media posts, and magazine articles as described in act 306. In some examples, textual descriptions may be a summary of detected fashion entities (obtained from act 306 based on the multimodal AI model) in natural language, which summary can be generated by a text embedding transformer. In non-limiting examples, with reference to the example in FIG. 4, the textual descriptions may be generated using NLP rules and/or general LLM. For example, the input to the NLP rules and/or general LLM may be a structured list of fashion entities shown above that are extracted from the multimodal AI model (e.g., multimodal AI classifier 102 in FIG. 1) and their co-occurrence relationships. In non-limiting examples, the output textual summary may be a descriptive sentence (e.g., “Kendall Jenner wearing an oversized black leather jacket paired with sneakers, styled in a streetwear look.”).

In act 314, image embeddings may be generated from product images, social media visuals, and runway photos using an image embedding transformer. In non-limiting examples, the text embedding transformer may include Bert (Bidirectional Encoder Representations from Transformers) model. The image embedding transformer may include a CLIP (Contrastive Language-Image Pre-training) model. It is appreciated that other suitable text/image embedding transformers may be used. Once the text/image embeddings are generated, process 300 may proceed to act 316 to store the generated embeddings in the fashion knowledge base (e.g., 106 in FIG. 1).

Having described acts 302-316, it is shown that tagging 320 extracts fashion entities which are used to generate both fashion knowledge graph and vector-based embeddings. Take the example in FIG. 4, from the extracted fashion entities, co-occurrence relationships may be extracted as:

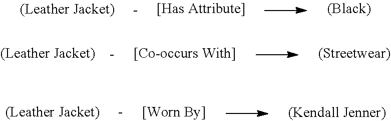

These fashion entities and their co-occurrence relationships may be used to construct/update the fashion knowledge graph (e.g., 112 in FIG. 1). The extracted fashion entities and/or co-occurrence relationships may also be used to generate vector-based embeddings (e.g., 110 in FIG. 1). For example, the extracted fashion entities and/or co-occurrence relationships may be used to generate textual descriptions of the product in a fashion related social media post, at act 314. Then, the textual descriptions and the image associated with the post are respectively converted to text and image embeddings (e.g., vectors 110 in FIG. 1).

With reference to FIG. 3, the multimodal AI model (e.g., used in act 306) is further described. Multimodal AI model (e.g., multimodal AI classifier 102 in FIG. 1) may be trained on labeled fashion data sets and fine-tuned using weakly supervised learning (e.g., leveraging large-scale e-commerce data where product attributes are already labeled). In some embodiments, tagging is developed through a two-stage training approach to ensure accurate and scalable fashion attribute extraction:
Stage 1: Supervised Training on E-Commerce Data
   Train a multimodal AI Model using structured, labeled e-commerce products where attributes (e.g., color, material, pattern) are explicitly tagged.
   A text Model (e.g., NLP-based model) learns from product titles/descriptions, while an image Model (Vision-based) detects visual attributes.
   Outputs are fused to create a base tagging model.
Stage 2: Self-Training on Unlabeled Data
   Apply the trained model to unlabeled social media and runway images to generate attribute predictions.
   Filter high-confidence predictions and use them to further fine-tune the model, improving its adaptability to diverse real-world fashion data.

In some embodiments, the predictions from the multimodal AI classifier may be output with a probability distribution over pre-defined labels. These probabilities represent the classifier's confidence in each predicted attribute, which can be used to filter the predictions. For example, predicted fashion entities having a confidence value exceeding a threshold, e.g., 0.85, may be filter as high-confidence predictions, then used as pseudo-labels to fine-tune the model. In non-limiting examples, softmax layer (for single-label tasks) may be used to extract the fashion entities.

Fine-tuning an AI model can be performed using any known technologies. For example, fine-tuning may involve using both ground-truth labels and high-confidence pseudo-labels to perform back-propagation, updating the model's deep learning weights. Fine-tuning may result in an improved AI classifier that can better generalize to real-world and unlabeled data such as social media and runway images. It is appreciated that process 300, including tagging 320, can be automated, eliminating the need for manual tagging while ensuring consistent, scalable fashion intelligence in FashionLLM.

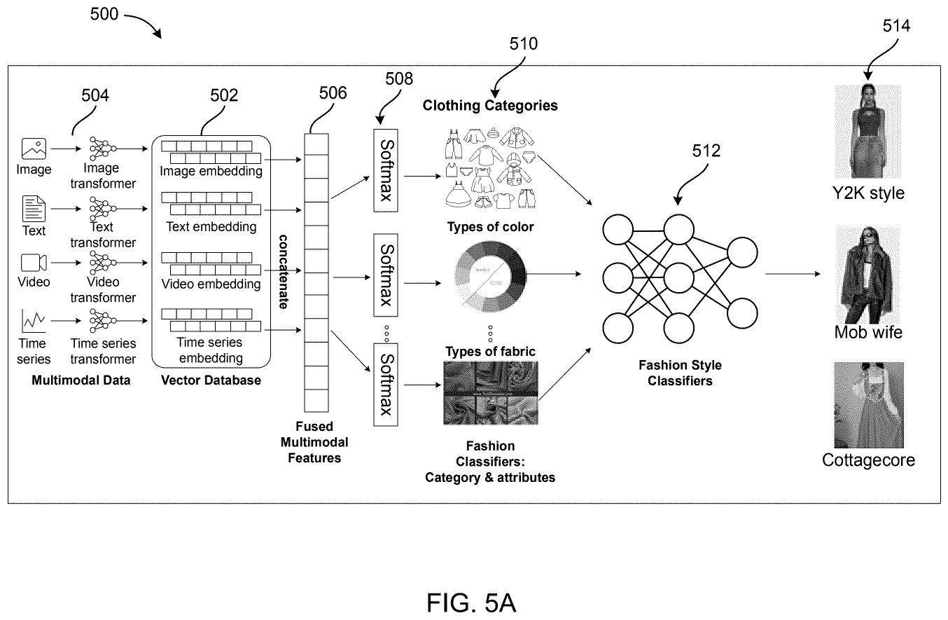

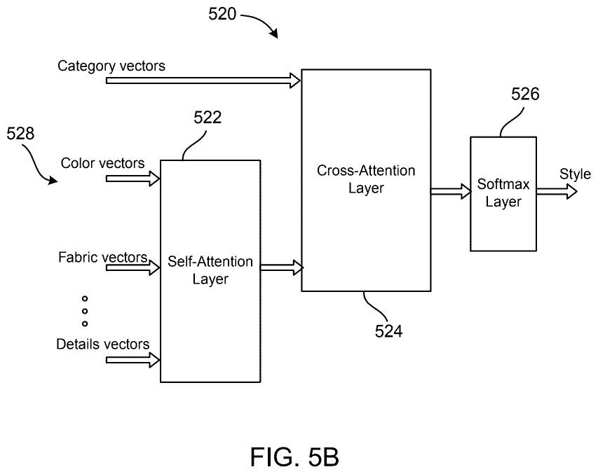

FIG. 5A is a schematic diagram of a fashion style classification system 500 for use in the fashion attributes tagging, according to some embodiments. In some embodiments, fashion style classification system 500 may be implemented in the multimodal AI classifier (102 in FIG. 1). The fashion style classification system may leverage attention mechanisms to enhance fashion style prediction, which is further described herein.

In some embodiments, system 500 may include a vector database 502 storing multimodal vector-based embeddings generated from processing multimodal data 504 such as image, text, video, time-series. These embeddings may be generated using respective embedding transformers similarly described above and further herein (see FIG. 3). For example, image embeddings may be generated by image transformer for visual features. Text embeddings may be generated by text transformer to understand textual descriptions. Video embeddings may be encoded by video transformer for sequential fashion patterns.

In some embodiments, multimodal data 504 may be the same as data source 108 (FIG. 1). Text and image embeddings may be the same as text and image embeddings in embodiments in FIG. 3. Text transformer and image transformer may be similar to those described in embodiments in FIG. 3, such as BERT (for text) and CLIP (for image). Similarly, vector database 502 may be implemented to store vectors 110 (FIG. 1).

In FIG. 5A, multimodal vector-based embeddings in vector database 502 may be stored for each fashion item, e.g., the same social media post, article, or product listing that include different types such as image embeddings (color, texture, shape, pattern), text embeddings (semantic meaning of descriptions), and video embeddings (motion-based fashion sequences). These embeddings for the same fashion item may be fused into fused multimodal features 506. For example, the text, image, and any/or additional metadata (e.g., timestamp) from the same fashion item may be concatenated into a unified multimodal feature representation. As such, the resulting vector representation captures the full context of that specific fashion item or look.

In non-limiting examples, each modality (e.g., text, image) is projected into a shared 512-dimensional (512-D) space using a learned projection layer. The embeddings can be text embedding (projected): 512-D, image embedding (projected): 512-D, with the concatenated embedding having a dimension of 1024-D. These embeddings may be stored in the vector database or passed to downstream models (e.g., for retrieval, recommendation, or style classification).

In FIG. 5A, system 500 may include a plurality of first classifiers 508, e.g., softmax classifiers. These classifiers classify the fashion attributes and categories before fashion style prediction. In non-limiting examples, multiple softmax classifiers may be included in the plurality of classifiers 508 respectively for each of the fashion categories (dress, jacket) or attributes (e.g., color, fabric, pattern, fit, detail etc.). These classifiers may be trained in a similar manner using existing training data for multimodal AI classifier, in some examples. The training may be performed using any suitable known technologies, e.g., deep learning propagation algorithms. Although it is shown that softmax classifiers are used, it is appreciated that other suitable types of classifiers and training thereof may be used.

In FIG. 5A, system 500 may further include a second classifier 512, e.g., fashion style classifier to predict final fashion style (aesthetics) 514, based on predicted fashion categories and attributes. FIG. 5B is a schematic diagram of a structure of a fashion style classifier 520. In some embodiments, fashion style classifier 520 may be implemented in the classifier 512 (in FIG. 5A). Fashion style classifier 520 may use an attention-based classifier that assigns probability scores to fashion styles to improve accuracy of fashion style prediction. In some examples, the attention mechanism may include self-attention layer 522, which captures relationships between attributes (e.g., Leather (fabric)+Black (color)+Studded (details)→Rock); and cross-attention layer 524, which combines the same category with different attributes that can lead to different styles, and vice versa (e.g., Leather+Jacket→Rock vs. Leather+Dress→Luxury). The fashion style classifier 520 may further include a final style classification layer 526 that maps the learned representation to fashion styles (e.g., Y2K, Mob Wife, Cottagecore). For example, the final style classification layer 526 may be a softmax layer. Now, the attention-based fashion style classifier 512 is further described in detail.

### Input

### Fashion Attributes

Example: Leather (fabric), Black (color), Studded (detail)
Each attribute is embedded as a dense vector aᵢ ∈ [symbol] ^{d}

### Category Embedding

Example: Jacket, Dress
Also embedded as c∈ [symbol] ^{d}

### Self-Attention Layer (Among Attributes)

Purpose: Captures the semantic interactions between attributes.
   E.g., Leather+Studded+Black together suggests Rock; individually, they may not.
Mechanism:
   Let A=[a₁, a₂, . . . , aₙ] be the attribute embeddings.

We apply three learnable linear projections to compute:

$$Q = A {W}_{Q} , K = {AW}_{K} , V = {AW}_{V}$$

Where:
W_{Q}, W_{K}, W_{V} ∈ [symbol] ^{d×d}^{ₖ} are trainable parameters.
Q, K, V ∈ [symbol] ^{n×d}^{ₖ}

Then compute self-attention:

$$SelfAttn ( A ) = softmax ( \frac{{QK}^{T}}{\sqrt{{d}_{k}}} ) V$$

$${Z}_{attr} = SelfAttn ( A ) {W}_{O} where ∈ {ℝ}^{{d}_{k} \times d}$$

Result: Attribute embeddings now carry relational meaning (e.g., leather feels different if paired with lace vs studs).

### Cross-Attention Layer (Attributes⇄Category)

Purpose: Align attributes with the product category to understand style context.
E.g., Leather+Jacket→Rock, but Leather+Dress→Glamorous or Luxury

### Mechanism:

Let c∈ [symbol] ^{d} be the category embedding (e.g., “jacket”).

We compute: Q_{c}=cW_{Q}^{c}, Kₐ=ZₐₜₜᵣW_{K}^{a}, Vₐ=ZₐₜₜᵣW_{V}^{a}

Where:
W_{Q}^{c}∈ [symbol] ^{d×d}^{ₖ}
W_{K}^{a}, W_{V}^{a}∈ [symbol] ^{d×d}^{ₖ}

Then compute cross-attention:

$$CrossAttn ( c , {Z}_{attr} ) = softmax ( \frac{{Q}_{c} {K}_{a}^{T}}{\sqrt{{d}_{k}}} ) {V}_{a}$$

This yields a fused style representation z∈ [symbol] ^{d}^{_{k&}}

Output: A style representation vector that fuses both attribute interactions and category alignment.

### Style Classification Layer

Pass the fused vector z∈ [symbol] ^{d}^{ₖ} through an MLP for final style prediction:

$$h = ReLU ( {W}_{i} z + {b}_{1} ) , \hat{y} = softmax ( {W}_{2} h + {b}_{2} )$$

where:
W₁ ∈ [symbol] ^{h×d}^{ₖ}, W₂ ∈ [symbol] ^{m×h}
m: number of style classes (e.g., Y2K, Rock, Minimalist)
Output: ŷ∈ [symbol] ^{m}: predicted probabilities over styles

In the attention-based fashion style classifier, attention makes style predictions more accurate and context-aware. The advantages are evident in the various components in the classifier. For example, self-attention models how attributes interact with each other (e.g., leather+studs+black); cross-attention adapts the meaning of attributes based on product category (e.g., jacket vs dress). As a result, fashion style classifier 512 and the softmax classifiers 508 together map the fused representation to a concrete fashion style label.

In non-limiting examples, the input of the fashion style classifier includes attributes (Leather, Studded, Black) and category (Jacket). In the fashion style classifier, the self-attention refines attribute vectors to highlight strong co-occurrence; and the cross-attention aligns attributes to Jacket context. The output fashion style is Rock (92%), Streetwear (6%), Y2K (2%).

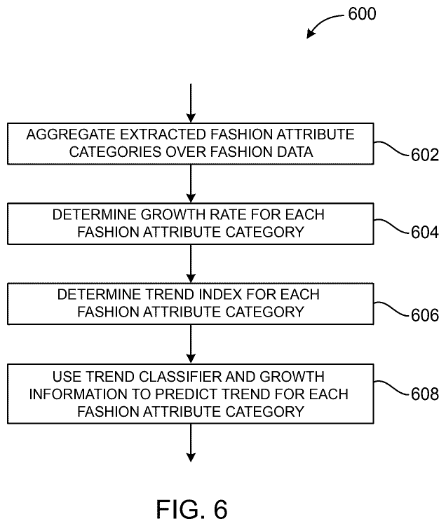

FIG. 6 is a flow diagram of an example process 600 of determining fashion trends, according to some embodiments. With reference to FIG. 1, process 600 may be implemented in the FashionLLM 120 to compute trend information based on the fashion data from the data source 108. Accordingly, fashion knowledge base 106 may store trend information 118. In some examples, trend information 118 may include trend indices and growth rates for respective fashion categories. For example, via process 600, data from data sources 108 may be aggregated to compute trend indices and growth rates for all fashion categories, such as product (e.g., cargo pants), color (e.g., black), fabric (e.g., denim), pattern etc. In some embodiments, trend information may be obtained based on the output of the multimodal AI classifier 102 and the fashion knowledge graph 112, as will be described further in detail.

Returning to FIG. 6, process 600 may be implemented to determine fashion trend indices. For example, process 600 may include aggregating extracted fashion attribute categories over fashion data, at act 602. The extracted fashion attribute categories may be extracted from the classifiers (e.g., 508 in FIG. 5A). Process 600 may further determine growth rate for each fashion attribute category, at act 604. Process 600 may proceed to act 606 to determine trend index for each fashion attribute category, which is described in the example below.

In some embodiments, trend index is a ranking metric used to identify hot product trends, aesthetic trends, and design trends by analyzing sales, social media engagement, search interests, and runway exposure. Each metric now includes both current value and growth rate to ensure accuracy in trend forecasting. A trend index may be calculated and normalized based a weighted sum of these metrics. For example, Trend Index=w1·Sales Score+w2·Engagement Score+w3·Search Score+w4·Runway Exposure Score, where weights (w1,w2,w3,w4) are based on their relevance to trend forecasting.

In non-limiting examples, a Product Trend index (e.g., Cargo Pants) and growth rate may be determined based on a combination of the following scores, with examples.

### Sales Score (Current+Growth)

Current Sales Volume: 10,000 units sold
Growth Rate: (10,000-7,500)/7,500=33.3
Normalized Sales Score: 75

### Engagement Score (Current+Growth)

Current Mentions: 50,000
Growth Rate: +45% compared to last 30 days
Normalized Engagement Score: 85

### Growth Score (Search Trends Search Volume Increase)

Search Trends search interest: +55% over last 30 days
Final Growth Score: 84
where Search Trends search interest may be obtained via a search engine API, such as Google search API.

### Runway Exposure Score (Current+Growth)

Seen in 8 runway collections.
Last season: 5 appearances→60% growth in runway presence
Final Runway Exposure Score: 82

$$Trend Index = ( 0.4 \times 75 ) + ( 0.3 \times 85 ) + ( 0.2 \times 84 ) + ( 0.1 \times 82 ) = 80.1 .$$

Having described an example of calculating trend index and growth rate (over time) for a given product, it is appreciated that trend index and growth rate (over time) can be determined for all fashion categories and aesthetics and stored in the fashion knowledge base (e.g., 106 in FIG. 1).

In some embodiments, hot trends may be classified based on the calculated trend indices as described above. For example, in the above example, the calculated trend index 80.1 is above a threshold 0.8, thus the associated product (Cargo Pants) is classified as a hot product. In a similar manner, hot trends for other fashion categories, e.g., fashion style, design, color, fabric etc. may all be determined.

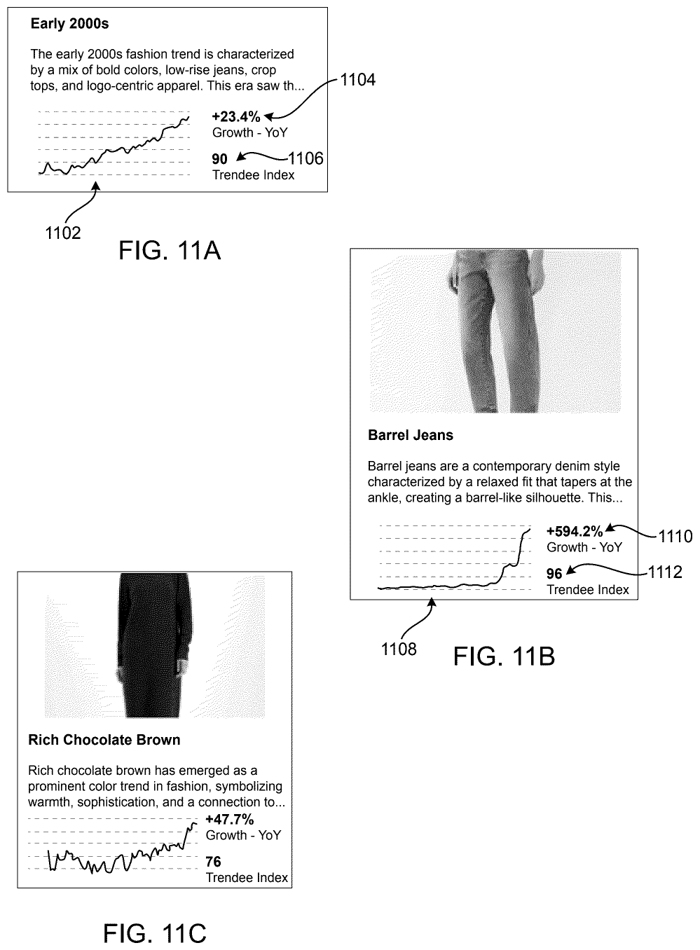

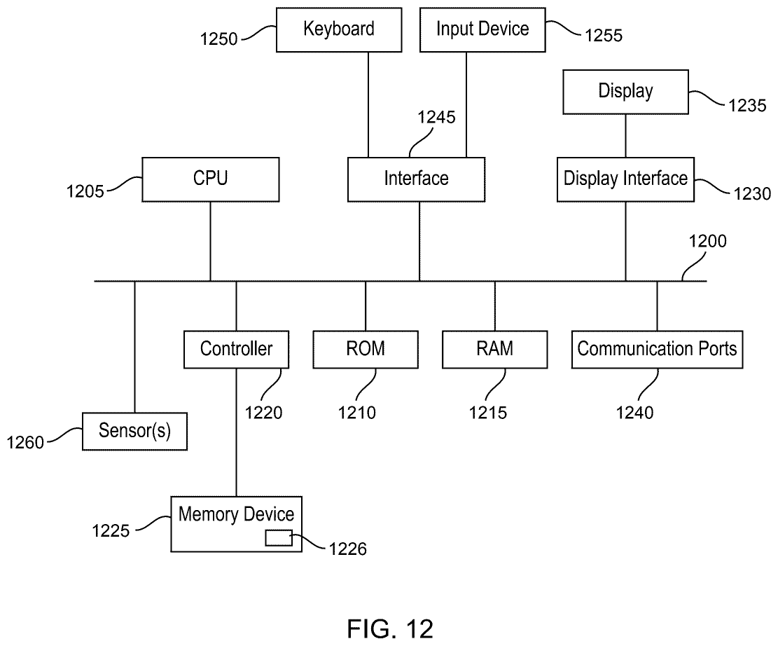

In some embodiments, trend index and growth rate may also be displayed/used together to provide trend insights to a user and help the user to make better decisions. For example, as shown in FIG. 11A, a growth rate 1104 (which is calculated from growth curve 1102) and a trend index 1106 are simultaneously displayed on a user screen for aesthetic Early 2000s. This may help the user to assess the trend insights and take appropriate action. In non-limiting examples, comparing FIG. 11A and FIG. 11B, it is shown that Early 2000s and Barrel Jeans have similar trend indices, but significantly different growth rates. However, in FIG. 11A, a steady growing trend is shown with a growth rate 23.4%. This provides insights that Early 2000s is more predictable and good for long-term planning. In contrast, in FIG. 11B, a viral trend with a low start and sudden surge is shown. This provides insights that Barrell Jeans is a fast-rising and short-term trend, and it suggests fast action before the trend may fade away.

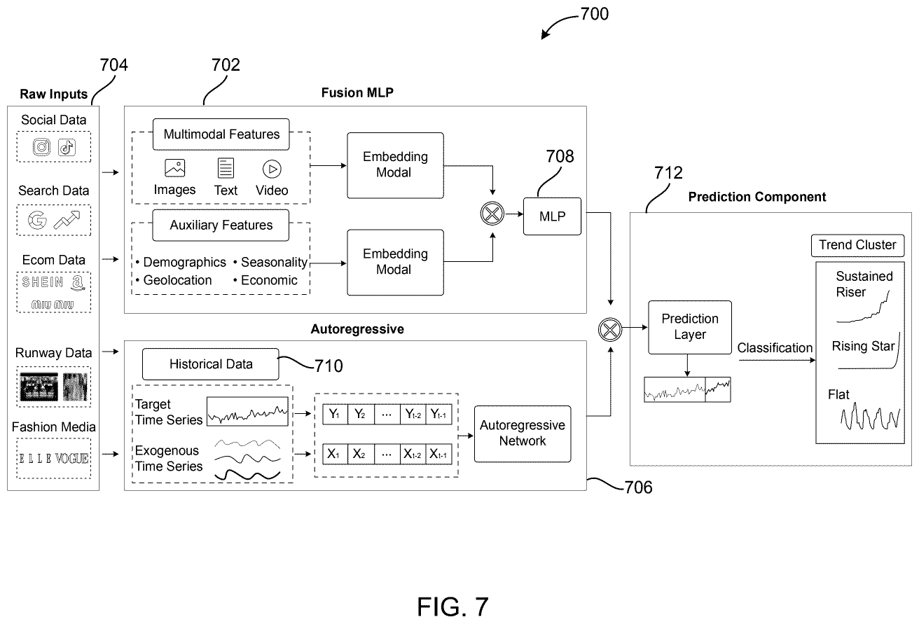

Returning to FIG. 6, process 600 may be implemented to determine a fashion trend using a trend classifier and growth rate (as describe above) to predict trend for a given fashion attribute category, at act 608. The trend classifier is further described in FIG. 7.

FIG. 7 is a schematic diagram a fashion trend classifier system 700, according to some embodiments. In some embodiments, fashion trend classifier system 700 may be implemented in FashionLLM (e.g., 120 in FIG. 1) to predict the trend for a given fashion attribute category. As shown, fashion trend classifier system 700 may include a fusion MLP 702, a neural network system that combines embeddings from different sources 704. MLP stands for Multi-Layer Perceptron, a basic feed-forward neural network including one or more fully connected (dense) layers, and nonlinear activation functions (e.g., ReLU). In this architecture, MLP is used to learn from the fused embedding vector and pass a dense representation into downstream tasks such as forecasting or trend classification.

As described similar to embeddings in embodiments in FIG. 3, embeddings to be fused in fusion MLP 702 may include embeddings converted from multimodal fashion features (e.g., image/text/video) and embeddings converted from auxiliary features (e.g., demographic, seasonality, etc.). In some embodiments, auxiliary features are non-image/non-text information that provide additional context about the data. Examples of auxiliary features include demographics (age, gender, region of users posting or buying), geolocation (where the product was posted, sold, or trended), seasonality (e.g., time of year, holiday cycles, etc.) and economic indicators (e.g., CPI, spending trends, income levels).

Auxiliary features may be obtained in various manners. For example, demographic and geolocation features can be inferred using multimodal parsing of user profile images. Seasonality patterns may be derived from statistical analysis of historical time series data. Economic indicators may be obtained from available third-party datasets. These various auxiliary features may be integrated into the model via fashion with the fashion features to provide rich context and improved accuracy for fashion trend prediction. The fusion may be similar to concatenation as described in embodiments in FIG. 5A. As a result, the embeddings from multimodal fashion features and auxiliary features are converted to one unified representation 708 for prediction. Auxiliary features may be fused with fashion features to improve prediction robustness.

With further reference to FIG. 7, fashion trend classification system 700 may further include autoregressive network 706, which can be a model (e.g., RNN, GRU, Transformer) trained to predict future trends based on past observations. The past observations may include historical data 710. This refers to the time-series data used to model and forecast trend dynamics. In some embodiments, historical data may include target time series (the main variable to be predicting, e.g., daily/weekly frequency of “faux fur coat” mentions/posts/sales) and exogenous time series (external inputs, related but not directly predicted variables, e.g., number of runway appearances, influencer mentions, Google search interest, etc.). Autoregressive model 706 learns the temporal dependencies (e.g., if something spikes seasonally or rises after influencer surges) and uses the historical data (observations) to predict the time series dynamics.

In FIG. 7, fashion trend classification system 700 may further include a prediction component 712, which may be an AI model (neural net) trained to forecast future trend levels (regression) or classify the trend into categories (e.g., Sustained Riser, Rising Star, Fast Decliner). Training of the prediction component 712 may be supervised learning with labeled historical trend trajectories using any known or later developed techniques, such as gradient descent. Loss functions may be MSE for time-series forecast for regression, and cross-entropy for trend type classification. During inference, the inputs to the prediction component 712 may be aggregated fashion data, such as: faux fur coat by product; color=red, fabric=satin by attribute; or Y2K, Mob Wife by fashion style.

For each fashion item (e.g., product/category/style), the system aggregates social mentions, engagement metrics, e-commerce data, search interest, and transforms them into embeddings from fusion MLP 702 and time series dynamics from autoregressive network 706, which are then fused and provided to the prediction model 712 to predict trend trajectory and classification.

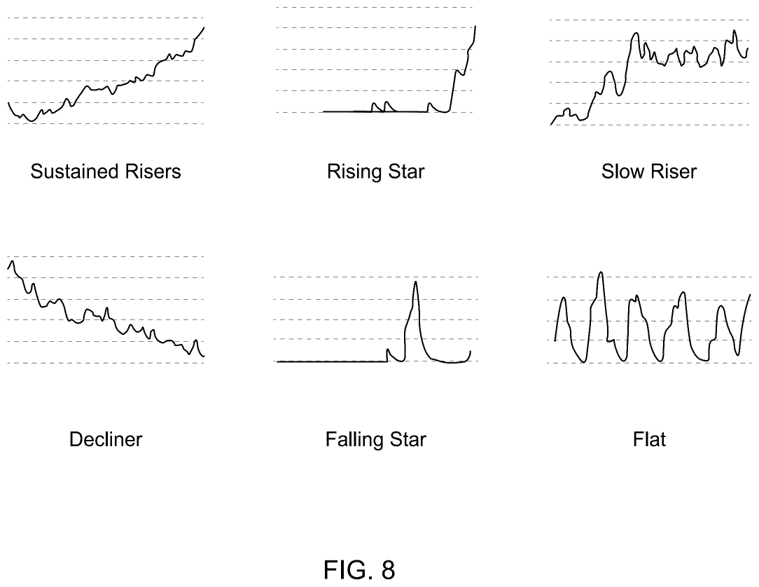

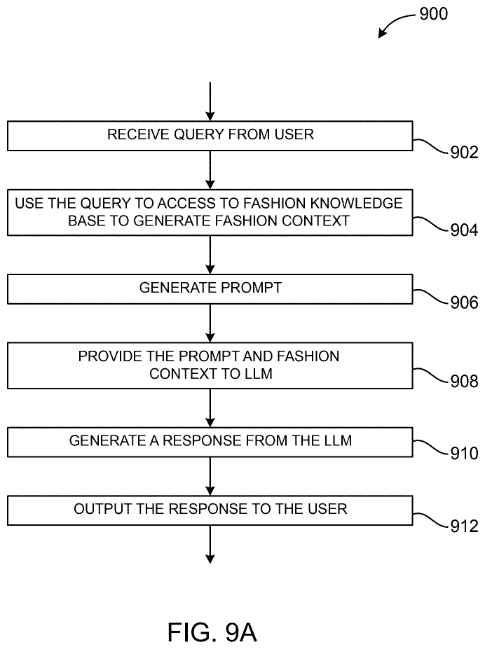

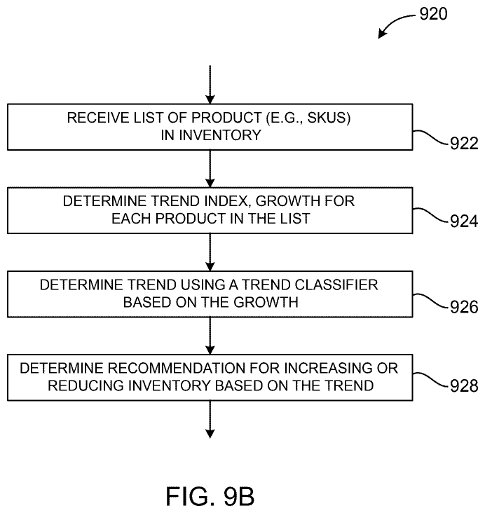

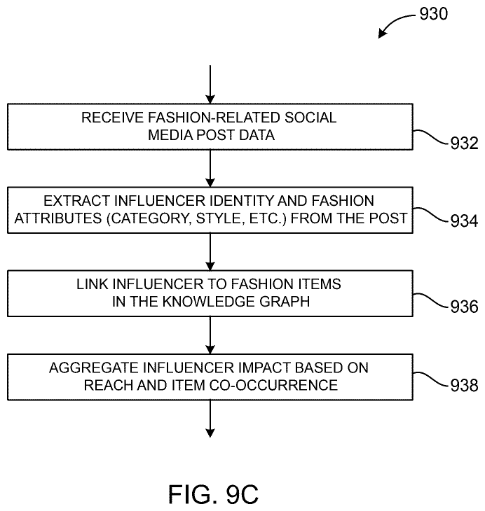

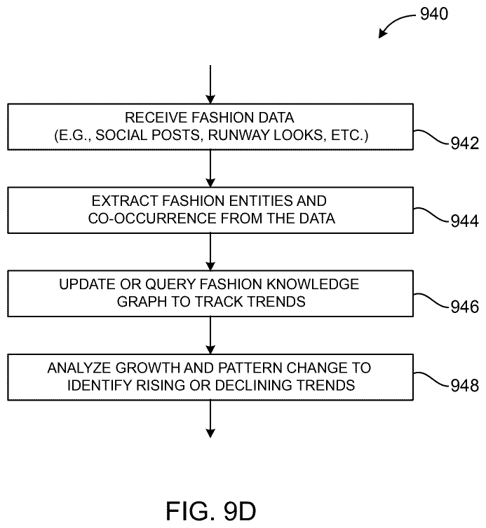

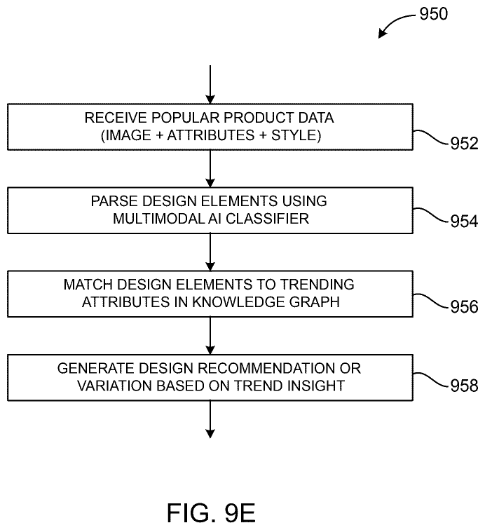

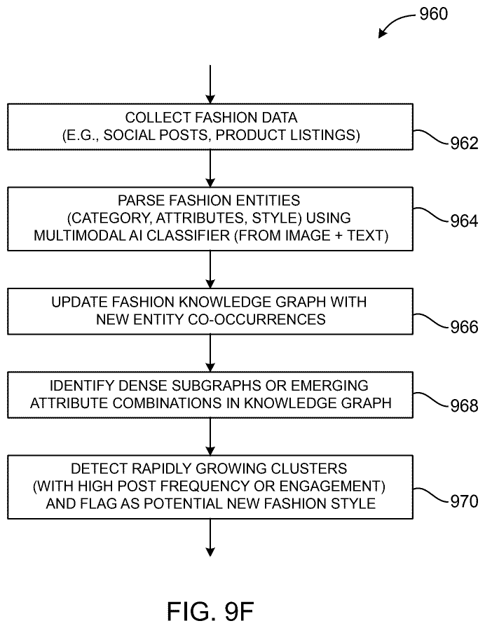

FIG. 8 illustrates examples of fashion trend trajectories and classifications as can be determined by a fashion trend classification system 700 (FIG. 7), according to some embodiments. In the examples shown, sustained risers corresponds to consistent growth over multiple months or years. Rising star corresponds to sudden surge in popularity in recent weeks. Slow riser corresponds to gradual increase in popularity over time. Decliner corresponds to steady decline over multiple months or years. Falling star corresponds to rapid decline after a sudden peak. Flat corresponds to minimal or no change in trend over time. These are just examples of trend classifications, and it is appreciated that other trend styles may be possible. As will be further described in embodiments in FIG. 9F, new fashion styles may be identified and added to the classifier.

Having described the fashion trend analysis system 100 FIG. 1 and various components in FIGS. 2A-8, by leveraging co-occurrence data from social media, e-commerce, and runway sources, FashionLLM (120) may be used to enable various fashion related applications as shown in FIGS. 9A-9F. These applications may be implemented in GenAI applications (e.g., 116 in FIG. 1). In these applications, the fashion knowledge base acts as a structured memory of the fashion world-capturing how people, styles, products, and elements are connected, letting users query, and predicting and recommending based on those evolving connections.

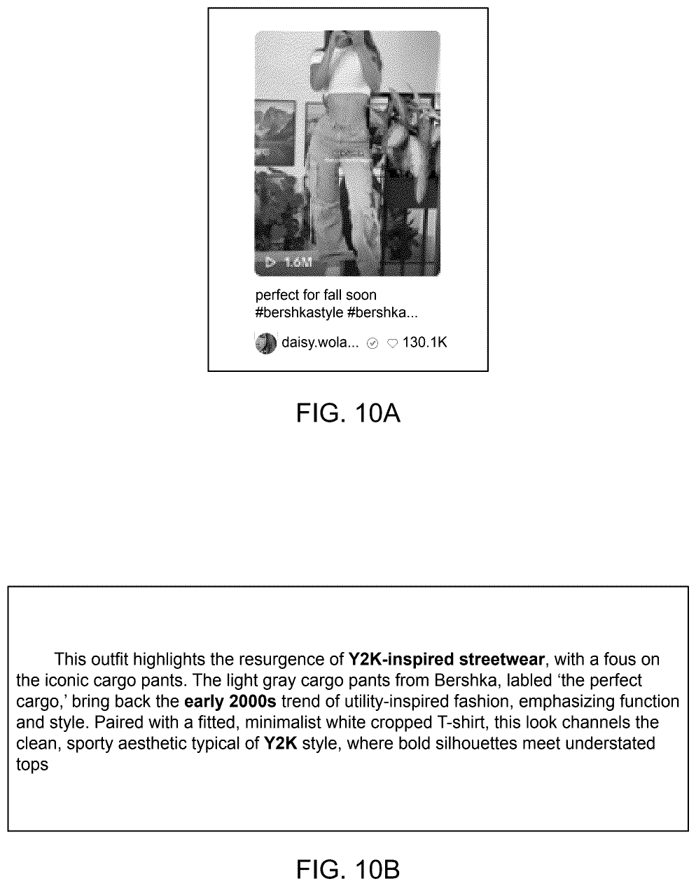

FIG. 9A is a flow diagram of an example process 900 for generating a response using a fashion knowledge base (e.g., 106 in FIG. 1), according to some embodiments. Process 900 may start with receiving a query from a user, at act 902; using the query to access to fashion knowledge base (e.g., 106) to generate fashion context, at act 904; generating a prompt, at act 906; providing the prompt and fashion context to LLM (e.g., 114), at act 908; generating a response from the LLM, at act 910; and outputting the response to the user, at act 912. As shown in FIG. 1, the LLM 114 is already trained (e.g., by OpenAI or others) but can be enhanced through RAG using the fashion knowledge base (106) contributed by tagging. The context retrieved from the fashion knowledge base may include relevant fashion entities, product attributes, and trends (e.g., trend information). Details of these acts will be further described with an example in FIGS. 10A-10B.

FIG. 10A is an example of a fashion social media post, according to some embodiments. FIG. 10B is an example of a summary generated by the system and method described in the present disclosure for the fashion social media post shown in FIG. 10A. The results in FIG. 10B may be generated by implementing process 900, which is explained with reference to FIG. 9A.

Returning to FIG. 9A, a user query “What is the style and trend insight of this outfit?” and optional image, text, or both may be received at act 902. Process 900 may include act 904 to generate context. In this act, the user query image/text may be parsed to multimodal AI classifier (e.g., 102 in FIG. 1) to extract fashion entities in a similar manner as described above in embodiments in FIGS. 1, 3 and 5. For example, the extracted fashion entities include categories (cargo pants, cropped T-shirt), attributes (light gray, fitted, minimalist, utility) and detected style candidates (Y2K, streetwear). These fashion entities and the query image are converted to query embedding vectors.

In some embodiments, in act 904, the query embedding vectors are used to query the vector database (e.g., 110 in FIG. 1) to retrieve similar past fashion examples. In some examples, past fashion examples may be retrieved from the fashion knowledge base using embedding similarity (e.g., cosine similarity). In the current example, the past fashion examples may include runway looks, influencer posts, best-selling products with similar style. The return from the fashion knowledge base includes matching items with associated tags and metadata.

Additionally and/or alternatively, in act 904, the parsed fashion entities may be used to query the fashion knowledge graph (e.g., 112 in FIG. 1) for attribute co-occurrence patterns, style association strength (e.g., cargo pants⇄Y2K), trend data (e.g., trend index, frequency, engagement, YoY growth), and related influencer mentions or brand styles. As a result, the augmented context includes top-K embedding matches (e.g., retrieved examples with style tags, descriptions) and knowledge graph facts. For example, in the current example, knowledge graph facts include:
“Cargo pants appear in 72% of recent Y2K-tagged influencer posts”
“Y2K and utility fusion trend has increased 45% YOY”
“Cropped T-shirts commonly co-occur with minimalist styling in Y2K”
   The context is packaged into a structured format or natural language snippets and passed to the LLM (e.g., 114 in FIG. 1).

With further reference to FIG. 9A, a prompt is generated in act 906. In the current example, the prompt template becomes:
“Based on the following outfit description, matched examples, and trend metadata, describe the aesthetic, style category, and cultural relevance of this look.”
“Use a confident, editorial tone like a fashion magazine article.”

The context is in a form of meta data:

```
{
  “image_description”: “Light gray cargo pants with fitted white
cropped tee”,
  “matched_examples”: [“Look X from NYFW 2024”, “Influencer post (Jan
2024)”],
  “detected_styles”: [“Y2K”, “Streetwear”, “Utility”],
  “trend_signals”: {
    “Y2K”: “+45% YoY growth”,
    “cargo pants”: “high co-occurrence with Gen Z influencers”,
    “utility trend”: “rising in both e-commerce and runway data”
  }
}
```

Subsequently, the prompt and fashion context are provided to LLM (e.g., 114 in FIG. 1), at act 908, and a response is generated at act 910. An example of the final response is in a natural language output, which is shown in FIG. 10B.

FIG. 9B is a flow diagram of an example process 920 of product inventory recommendation, according to some embodiments. This process helps retailers optimize their inventory by analyzing SKU performance and identifying which products to restock or reduce. In some embodiments, process 920 may include receiving a list of product (e.g., SKUs) in inventory, at act 922. In non-limiting examples, the input to process 920 is a retailer SKU list. For example, the retailer provides a list of SKUs (product identifiers) from their inventory. Process 920 may further include determining trend index, growth rate for each product in the list, at act 924; and determining trend using a trend classifier based on the growth, at 926. Acts 924, 926 may be performed in a similar manner as described in embodiments in FIG. 6. Act 926 may be performed using trend classifier in FIG. 7. As a result of acts 924, 926, each SKU is matched with trend index and trend growth rate, from e-commerce, social media, and runway sources, in a manner as described above.

Process 920 may further determine recommendation for increasing or reducing inventory based on the trend, at act 928. In non-limiting examples, the recommendation may include increasing stock in the inventory, if a product shows high trend index value and strong growth (e.g., sustained risers or rising stars). If the detected trend is seasonal demand (e.g., seasonal risers), restocking may be recommended. Conversely, the recommendation may include reducing stock in the inventory or phasing out, if the trend is fading (e.g., falling stars).

In a non-limiting example, the SKU is faux fur coat. Trend index is 95, growth rate is +120%. The recommendation is to increase stock. This is an example of detecting increasing trend trajectory of faux fur coat before a new style Mob Wife that defines the faux fur coat becomes known. In another example, the SKU is Tie-Dye T-Shirt. Trend index is 45, YoY Growth: −60%. The recommendation is to reduce stock because the trend is fading.

In another non-limiting example, style recommendation application may be implemented to recommend style based on knowledge graph. It finds styles in product design across brands and marketplaces, to enhance recommendations. The knowledge graph maps relationships between design elements and style concepts, allowing more meaningful recommendations. For example:
Nodes=products, attributes, aesthetics, brands
Edges=stylistic similarity, co-styling, or shared features
When a user inputs a product or style (e.g., “Cottagecore dress”), the system traverses the graph to find related styles or products with similar attribute paths.
   In this example, the knowledge graph enables the recommendations to be based on shared fashion semantics, not just visual similarity.

FIG. 9C is a flow diagram of an example process 930 of influencer-based insights analysis, according to some embodiments. This process may determine which fashion elements are commonly worn by influencers to understand their impact on style adoption, based on the fashion knowledge graph (e.g., 112 in FIG. 1), which links fashion elements to influencers based on what they wear and post about.

In some embodiments, process 930 may include receiving fashion-related social media post data, at act 922; extracting influencer identity and fashion attributes (category, style, etc.) from the post, at act 934; linking influencer to fashion items in the knowledge graph, at act 936; and aggregating influencer impact based on reach and item co-occurrence, at act 938.

In non-limiting examples,
Nodes=influencers, attributes, products
Edges=“Wears” or “Mentions” relationships
By analyzing these connections, the system can identify which influencers are driving which trends.
Example: Influencer A frequently wears “Fur Coats”+“Gold Accessories”→linked to “Mob Wife” aesthetic node.
   In this example, the knowledge graph enables tracing of influence paths, quantifying influencer impact on style propagation.

FIG. 9D is a flow diagram of an example process 940 of fashion trend analysis, according to some embodiments. This process identifies frequently co-occurring attributes and categories in fashion products across different platforms, based on knowledge graph. In some embodiments, process 940 may include receiving fashion data (e.g., social posts, runway looks, etc.), at act 942; extracting fashion entities and co-occurrence from the data, at act 944; updating or querying fashion knowledge graph to track trends, at act 946; and analyzing growth and pattern change to identify rising or declining trends, at act 948.

In non-limiting examples,
Nodes=product categories, attributes (e.g., fabric, color, style), brands
Edges=frequency of co-occurrence in social media posts, e-commerce listings, runway images
Over time, we can track edge weights (co-occurrence strength) to identify which combinations are gaining popularity.
Example: “Trench Coat”+“Belted”+“Neutral Tones” appears more frequently→indicates a trend.
   In this example, the knowledge graph enables automated discovery of rising attribute combinations through edge analysis and growth tracking.

In another non-limiting example of process 940, the system may determine “style of the day” by collecting the most popular fashion-related daily social media posts and analyzing their trends using FashionLLM. Each post is evaluated for emerging styles, key fashion elements, and engagement metrics. Social media posts may be selected if a post has at least a threshold number of likes (e.g., 8,000 likes) and contains at least one fashion trend identified my multimodal AI classifier as described in the present disclosure. The output of the “style of the day” may include the selected post, the identified trend insights (e.g., trend index and/or growth rate), and the influencer associated therewith.

FIG. 9E is a flow diagram of an example process 950 of data driven AI fashion design, according to some embodiments. This process provides data support to facilitate AI design process and predict the popularity of the new design, using the fashion knowledge graph, which provides structured knowledge about what combinations of attributes are trending, helping guide design decisions. In some embodiments, process 950 may include receiving popular product data (e.g., image, attributes, style), at act 952; parsing design elements using multimodal AI classifier, at act 954; matching design elements to trending attributes in knowledge graph, at act 956; and generating design recommendation or variation based on trend insight, at act 958.

In non-limiting examples, designers input proposed attributes (e.g., “Ruffled Skirt”+“Pastel”+“Organza”). The fashion knowledge graph (e.g., 112 in FIG. 1) checks: whether this combination is trending; which styles it's connected to; and related influencer or product success stories, and predict how the design might perform based on attribute-level trend data and their connections in the graph. In this application, the fashion knowledge graph provides predictive feedback for new designs by analyzing attribute-path popularity and historical success.

FIG. 9F is a flow diagram of an example process 960 of discovering new fashion style, according to some embodiments. In his process, instead of relying on predefined style categories, FashionLLM (e.g., 120 in FIG. 1) continuously learns new aesthetics from social media through its fashion knowledge graph (e.g., 112 in FIG. 1). The system collects social media posts, influencer outfits, and fashion articles, and extracts fashion attributes (e.g., leather, oversized, gold accessories) to identify recurring patterns that do not fit existing aesthetics. Examples of a recurring pattern may include frequent, growing subgraph in the knowledge graph.

In some embodiments, process 960 may include collecting fashion data (e.g., social posts, product listings), at act 962; parsing fashion entities (category, attributes, style) using multimodal AI classifier (from image and text), at act 964, updating fashion knowledge graph with new entity co-occurrences, at act 966; identifying dense subgraphs or emerging attribute combinations in knowledge graph, at act 968; and detecting rapidly growing clusters (with high post frequency or engagement) and flagging as potential new fashion style, at act 970.

In the context of a fashion knowledge graph, dense subgraph may refer to style clusters. For example, a dense subgraph may include a cluster of nodes (fashion entities) that are highly interconnected, e.g., the entities frequently co-occur with one another in the data (e.g., the frequency of co-occurrence exceeds a frequency threshold). These clusters help identify new or evolving aesthetics before they are explicitly named in the market. In non-limiting examples, if fur coat, leopard print, and red lipstick form a dense subgraph, that may indicate a distinct style like “Mob Wife.”

In some embodiments, acts 962, 964, 966 may be performed in a similar manner as described in embodiments in FIGS. 1 and 3. In act 968, the system may use techniques such as frequent subgraph mining or density-based clustering to detect attribute clusters that appear frequently across many posts/products. In act 970, the system may apply temporal filtering to detect patterns that are growing over time (e.g., increasing post frequency, engagement, or retail presence). Once a strong co-occurrence pattern is detected, it is compared against existing style clusters embeddings already defined in the system to identify whether it is a new fashion style.

In comparing styles, each known style (e.g., Y2K, Streetwear, Cottagecore) has a style profile or vector centroid, e.g., in the form of embeddings, which can be obtained based on past labeled examples and defined by its attribute distribution in the knowledge graph. In comparing a new detected co-occurrence pattern to existing styles, the detected pattern is converted to a style embedding in a similar manner as described in embodiments in FIG. 7. Then cosine similarity or Euclidean distance to all existing style centroids is calculated. A new style is detected and flagged if no existing style is within a similarity threshold (e.g., cosine similarity <0.7) and the pattern is frequent and growing.

Using process 960, a detected pattern may be detected before it becomes a known trend. In a non-limiting example, fur coats, animal prints, and gold jewelry appearing together. This pattern has strong internal co-occurrence and appears frequent in influencer posts or social media. Yet, it does not closely match to any known styles (e.g., Y2K, Classic). In such case, the detected pattern is flagged as a candidate for a new style even before a style is known. In the instant example, the detected pattern defines the later arising style “Mob Wife.”

Once a new aesthetic concept is determined, it is linked to known styles in the knowledge graph. The system then tracks how this new aesthetic changes. Additionally, and/or alternatively, the system may collect posts/products that share the same rising co-occurrence pattern and assign a new style label in the fashion knowledge graph, which can be used for future prediction.

FIG. 11A is an example of graphical user interface that displays fashion style trend information generated by the system and method described in the present disclosure, according to some embodiments. FIG. 11B is an example of graphical user interface that displays product trend information generated by the system and method described in the present disclosure, according to some embodiments. FIG. 11C is an example of graphical user interface that displays design trend information generated by the system and method described in the present disclosure, according to some embodiments. In some embodiments, these screen shots may be displayed in the applications described in inventory recommendation (FIG. 9B), influencer-based insights (FIG. 9C) and/or data-driven AI design (FIG. 9E).

In these results, text summary may be generated by RAG based LLM described in FIG. 1. The trend index may be computed by aggregating multiple data signals, including social media engagement, product sales velocity, and runway exposure. It reflects the real-time momentum of a fashion item or trend. The growth curve is derived from the temporal volume of social media posts associated with the trend, and tracked after the trend is detected. In some embodiments, smoothing technique may be used to refine the shape of curve.

FIG. 12 depicts an example of internal hardware that may be included in any electronic device or computing system for implementing various methods in the embodiments described in FIGS. 1-11C. The components in FIG. 12 may be implemented in any of the systems or devices described above, for example, the fashion trend analysis system 100 in FIG. 1, fashion style classification system 500 in FIG. 5A, fashion trend classification system 700 in FIG. 7, and/or any user device communicating with the fashion trend analysis system (e.g., system 100 in FIG. 1). An electrical bus 1200 serves as an information highway interconnecting the other illustrated hardware components. Processor 1205 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a micro-controller, central processing unit (CPU) or a graphics processing unit (GPU) or a combination thereof. Read only memory (ROM), random access memory (RAM), flash memory, hard drives, and other devices capable of storing electronic data constitute examples of memory devices 1225. A memory device, also referred to as a computer-readable medium, may include a single device or a collection of devices across which data and/or instructions are stored. The memory device may include a fashion knowledge graph or fashion knowledge base 1226.

An optional display interface 1230 may permit information from the bus 1200 to be displayed on a display device 1235 in visual, graphic, or alphanumeric format. For example, display device 1235 may display any of the output generated by the system, e.g., fashion trend (see FIGS. 10A-11C). An audio interface and audio output (such as a speaker) also may be provided. Communication with external devices may occur using various communication ports 1240 such as a transmitter and/or receiver, antenna, an RFID tag and/or short-range, BLE, or near-field communication circuitry. A communication port 1240 may be attached to a communications network, such as the Internet, a local area network, Wi-Fi, or a cellular telephone data network for facilitating communications between the system and the users.

The hardware may also include a user interface sensor 1245 that allows for receipt of data from input devices 1250 such as a keyboard, a mouse, a joystick, a touchscreen, a remote control, a pointing device, a video input device, and/or an audio input device, such as a microphone. Digital image frames may also be received from an imaging capturing device 1255 such as a video or camera that can either be built-in or external to the system. Other environmental sensors 1260, such as a location sensor and/or a temperature sensor, may be installed on system and communicatively accessible by the processor 1205, either directly or via the communication ports 1240.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. A method for determining fashion trend, the method comprising, by one or more processors:
determining fashion data associated with at least a given fashion style;
extracting multimodal fashion features from the fashion data;
determining historical fashion data associated with the given fashion style;
using a trained fashion trend classifier to determine a fashion trend for the given fashion style based on the multimodal fashion features and the historical fashion data associated with the given fashion style; and
causing to display the fashion trend for the given fashion style.

2. The method of claim 1, wherein determining the fashion data associated with the given fashion style comprises:
receiving a collection of fashion data comprising a plurality of fashion items each including text and/or image;
for each fashion item of the plurality of fashion items in the collection of fashion data:
using a set of trained classifiers corresponding to a plurality of fashion categories and attributes to determine respective fashion categories and attributes for the fashion item; and
using a trained fashion style classifiers and the respective fashion categories and attributes as input to the trained fashion style to determine a fashion style for the fashion item;
aggregating the collection of fashion data to determine the fashion data associated with the given fashion style as a subset of the plurality of fashion items whose fashion style correspond to the given fashion style.

3. The method of claim 2, wherein, for each fashion item of the plurality of fashion items, determining the respective fashion categories and attributes for the fashion item comprises:
using a trained multimodal artificial intelligence (AI) classifier to determine a respective set of features for the fashion item, the respective set of features comprising at least image embeddings and/or text embeddings for the fashion item; and
using the set of trained classifiers corresponding to the plurality of fashion categories and attributes, and the respective set of features as input to the set of trained classifiers, to determine the respective fashion categories and attributes for the fashion item.

4. The method of claim 3, wherein using the trained multimodal AI classifier to determine the respective set of features for each fashion item comprises:
using the trained multimodal AI classifier to extract fashion entities from the fashion item; and
determining co-occurrence relationships among the extracted fashion entities;
wherein:
the image embeddings in the respective set of features for the fashion item are determined using an image embedding transformer based on one or more images in the fashion item; and
the text embeddings in the respective set of features for the fashion item are determined using a text embedding transformer, based on textual description of the extracted fashion entities and the co-occurrence relationships among the extracted fashion entities for the fashion item.

5. The method of claim 4, wherein the textural description of the extracted fashion entities and the co-occurrence relationships for the fashion item comprises a summary of the extracted fashion entities and the co-occurrence relationships in a natural language.

6. The method of claim 2, wherein the trained fashion style classifier comprises:
a self-attention layer configured to receive the respective fashion attributes for the fashion item and capture relationships between the respective fashion attributes;
a cross-attention layer coupled to the self-attention layer and configured to receive the respective fashion categories for the fashion item and combine the respective fashion categories and the respective fashion attributes for the fashion item; and
a style classification layer coupled to the cross-attention layer to predict the fashion style for the fashion item based on learned representation from the cross-attention layer.

7. The method of claim 1, further comprising:
receiving a user query related to fashion trend;
using a fashion knowledge base to determine fashion context based on the user query, the fashion knowledge base comprising fashion vector features, fashion entities and co-occurrence relationships among the fashion entities;
providing the context and the user query to a large language model to generate response to the user query; and
output the response.

8. The method of claim 7, wherein the fashion knowledge base comprises a fashion knowledge graph containing a plurality of nodes representing the fashion entities and a plurality of edges connecting the plurality of nodes and representing the co-occurrence relationships among the fashion entities.

9. The method of claim 8, further comprising constructing/updating the fashion knowledge graph by:
receiving a collection of fashion data comprising a plurality of fashion items each including text and/or image;
for each fashion item of the plurality of fashion items in the collection of fashion data:
using a trained multimodal AI classifier to extract fashion entities from the fashion item;
determining co-occurrence relationships among the extracted fashion entities;
constructing/updating the fashion knowledge graph with the extracted fashion entities and the co-occurrence relationships.

10. The method of claim 9, further comprising:
identifying dense subgraphs in the fashion knowledge graph, each dense subgraph comprising a cluster of nodes for which frequency of co-occurrence among the cluster of nodes exceeds a frequency threshold; and
applying a temporal filtering to detect from the dense subgraphs a pattern having a growth exceeding a growth threshold;
comparing the pattern with patterns associated with fashion styles in the trained fashion style classifier; and
identifying the pattern as a potential new fashion style based on the comparing.

11. A system for determining fashion trend, the system comprising one or more processors configured to perform operations comprising:
determining fashion data associated with at least a given fashion style;
extracting multimodal fashion features from the fashion data;
determining historical fashion data associated with the given fashion style;
using a trained fashion trend classifier to determine a fashion trend for the given fashion style based on the multimodal fashion features and the historical fashion data associated with the given fashion style; and
causing to display the fashion trend for the given fashion style.

12. The system of claim 11, wherein determining the fashion data associated with the given fashion style comprises:
receiving a collection of fashion data comprising a plurality of fashion items each including text and/or image;
for each fashion item of the plurality of fashion items in the collection of fashion data:
using a set of trained classifier corresponding to a plurality of fashion categories and attributes to determine respective fashion categories and attributes for the fashion item; and
using a trained fashion style classifier and the respective fashion categories and attributes as input to the trained fashion style to determine a fashion style for the fashion item;
aggregating the collection of fashion data to determine the fashion data associated with the given fashion style as a subset of the plurality of fashion items whose fashion style correspond to the given fashion style.

13. The system of claim 12, wherein, for each fashion item of the plurality of fashion items, determining the respective fashion categories and attributes for the fashion item comprises:
using a trained multimodal artificial intelligence (AI) classifier to determine a respective set of features for the fashion item, the respective set of features comprising at least image embeddings and/or text embeddings for the fashion item; and
using the set of trained classifiers corresponding to the plurality of fashion categories and attributes, and the respective set of features as input to the set of trained classifiers, to determine the respective fashion categories and attributes for the fashion item.

14. The system of claim 13, wherein using the trained multimodal AI classifier to determine the respective set of features for each fashion item comprises:
using the trained multimodal AI classifier to extract fashion entities from the fashion item; and
determining co-occurrence relationships among the extracted fashion entities;
wherein:
the image embeddings in the respective set of features for the fashion item are determined using an image embedding transformer based on one or more images in the fashion item; and
the text embeddings in the respective set of features for the fashion item are determined using a text embedding transformer, based on textual description of the extracted fashion entities and the co-occurrence relationships among the extracted fashion entities for the fashion item.

15. The system of claim 14, wherein the textural description of the extracted fashion entities and the co-occurrence relationships for the fashion item comprises a summary of the extracted fashion entities and the co-occurrence relationships in a natural language.

16. The system of claim 12, wherein the trained fashion style classifier comprises:
a self-attention layer configured to receive the respective fashion attributes for the fashion item and capture relationships between the respective fashion attributes;
a cross-attention layer coupled to the self-attention layer and configured to receive the respective fashion categories for the fashion item and combine the respective fashion categories and the respective fashion attributes for the fashion item; and
a style classification layer coupled to the cross-attention layer to predict the fashion style for the fashion item based on learned representation from the cross-attention layer.

17. The system of claim 11, wherein the operations further comprise:
receiving a user query related to fashion trend;
using a fashion knowledge base to determine fashion context based on the user query, the fashion knowledge base comprising fashion vector features, fashion entities and co-occurrence relationships among the fashion entities;
providing the context and the user query to a large language model to generate response to the user query; and
output the response.

18. The system of claim 17, wherein the fashion knowledge base comprises a fashion knowledge graph containing a plurality of nodes representing the fashion entities and a plurality of edges connecting the plurality of nodes and representing the co-occurrence relationships among the fashion entities.

19. The system of claim 18, wherein the operations further comprise constructing/updating the fashion knowledge graph by:
receiving a collection of fashion data comprising a plurality of fashion items each including text and/or image;
for each fashion item of the plurality of fashion items in the collection of fashion data:
using a trained multimodal AI classifier to extract fashion entities from the fashion item;
determining co-occurrence relationships among the extracted fashion entities;
constructing/updating the fashion knowledge graph with the extracted fashion entities and the co-occurrence relationships.

20. The system of claim 19, the operations further comprise:
identifying dense subgraphs in the fashion knowledge graph, each dense subgraph comprising a cluster of nodes for which frequency of co-occurrence among the cluster of nodes exceeds a frequency threshold; and
applying a temporal filtering to detect from the dense subgraphs a pattern having a growth exceeding a growth threshold;
comparing the pattern with patterns associated with fashion styles in the trained fashion style classifier; and
identifying the pattern as a potential new fashion style based on the comparing.
